(19) United States
(12) Patent Application Publication
(10) Pub. No.: US 2026/0227325 A1
(43) Pub. Date: Aug. 6, 2026

(54) GAS MEASUREMENT DEVICE

(71) Applicant: Asahi Kasei Microdevices Corporation, Tokyo (JP)

(72) Inventors: Yuta Takagi, Tokyo (JP); Yuji Goda, Tokyo (JP); Keiichiro Kuwata, Tokyo (JP)

(73) Assignee: Asahi Kasei Microdevices Corporation, Tokyo (JP)

(21) Appl. No.: 19/530,278

(22) Filed: Feb. 4, 2026

(30) Foreign Application Priority Data
Feb. 6, 2025 (JP) 2025-018724
Jan. 28, 2026 (JP) 2026-012510

(51) Int. Cl. G01N 21/3504

(52) U.S. Cl. CPC G01N 21/3504; G01N 2201/1211; G01N 2201/12746

(57) ABSTRACT

A gas measurement device includes: a reflection part, reflecting irradiation light having a wavelength range of 2.5 μm or more and 3.5 μm or less and forming a detection space for a target gas; a reception part, generating a detection signal corresponding to an intensity at which the irradiation light is absorbed by the target gas; a calculation part, generating concentration information of the target gas based on the detection signal; and a heating part, heating the reflection part. The reflection part includes a metal portion containing aluminum and a protective film containing silicon. The calculation part acquires the detection signal and a heating state of the heating part as input information, and performs data acquisition for calibration according to the heating state.

### CROSS-REFERENCE TO RELATED APPLICATION

This application claims the priority benefits of Japan application serial no. 2025-018724, filed on February 6, 2025 and Japan application serial no. 2026-012510, filed on January 28, 2026. The entirety of each of the above-mentioned patent applications is hereby incorporated by reference herein and made a part of this specification.

### BACKGROUND

### Technical Field

The disclosure relates to a gas measurement device.

### Related Art

Japanese Patent Laid-open No. 2015-135258 discloses “a gas sensor control device in which a decrease in gas concentration detection accuracy due to temporal changes in a measurement environment of a non-dispersive infrared gas sensor is suppressed.”

### SUMMARY

In a first aspect of the disclosure, a gas measurement device is provided. The gas measurement device may include: an irradiation part, irradiating a target gas with irradiation light including a wavelength component in at least a portion of a wavelength range of 2.5 μm or more and 3.5 μm or less. Any of the above gas measurement devices may include: a reflection part, reflecting the irradiation light and forming a detection space for the target gas. Any of the above gas measurement devices may include: a reception part, generating a detection signal corresponding to an intensity at which the irradiation light is absorbed by the target gas. Any of the above gas measurement devices may include: a calculation part, generating concentration information of the target gas based on the detection signal. Any of the above gas measurement devices may include: a heating part, heating the reflection part. In any of the above gas measurement devices, the reflection part may include a metal portion containing aluminum and a protective film containing silicon. In any of the above gas measurement devices, the calculation part may be configured to calibrate conversion information for converting the detection signal into the concentration information. In any of the above gas measurement devices, the calibration may include data acquisition for the calibration. In any of the above gas measurement devices, the calculation part may acquire the detection signal and a heating state of the heating part as input information, and may perform data acquisition for the calibration according to the heating state.

In any of the above gas measurement devices, the calibration may further include: generation of a calibration parameter based on data for the calibration; and updating of the conversion information based on the calibration parameter.

In any of the above gas measurement devices, at least one of a frequency of data acquisition for the calibration and a frequency of generation of the calibration parameter based on data for the calibration may be higher than a frequency of updating of the conversion information based on the calibration parameter.

In any of the above gas measurement devices, the calculation part may calibrate the conversion information based on the detection signal acquired in a state in which a temperature of the reflection part or an amount of heat supplied by the heating part to the reflection part is higher than a set value.

In any of the above gas measurement devices, the gas measurement device may include: a temperature sensor, measuring a temperature of the reflection part.

Any of the above gas measurement devices may include: a humidity sensor, measuring humidity at a reflective surface of the reflection part. In any of the above gas measurement devices, the heating part may control the heating state based on the humidity.

In any of the above gas measurement devices, the calculation part may calibrate the conversion information based on the detection signal acquired in a state in which the reflection part is heated so that the humidity is 70% RH or less.

In any of the above gas measurement devices, the heating part may heat the reflection part to a first state in a case of measuring the concentration information of the target gas, and may heat the reflection part to a second state having a higher temperature than the first state in a case of calibrating the conversion information.

In any of the above gas measurement devices, the heating part may change the heating state of the reflection part. In any of the above gas measurement devices, the calculation part may estimate a state of the reflection part based on a change in the detection signal corresponding to a change in the heating state.

In any of the above gas measurement devices, the calculation part may determine whether the reflection part is in a state in which condensation has occurred or a state in which moisture has been adsorbed based on a change in the detection signal.

In any of the above gas measurement devices, the heating part may heat the reflection part to 43 °C or higher in a case of calibrating the conversion information.

In any of the above gas measurement devices, the heating part may heat the reflection part by passing a current through the metal portion of the reflection part.

In any of the above gas measurement devices, the metal portion may include a reflection area provided with a reflective surface. In any of the above gas measurement devices, the metal portion may include a heated area that is provided adjacent to the reflection area and has a higher electrical resistance than the reflection area. In any of the above gas measurement devices, the heating part may pass a current through the heated area.

In any of the above gas measurement devices, the heated area may include an area having a thickness of 1 μm or less in a direction perpendicular to a direction in which the current flows.

In any of the above gas measurement devices, the reflection part may include a protective film that is formed of a hydrophilic material and covers the reflective surface.

In any of the above gas measurement devices, the metal portion may contain aluminum. In any of the above gas measurement devices, the protective film may contain silicon.

In any of the above gas measurement devices, the irradiation light may be incident on the reflection part three or more times.

In any of the above gas measurement devices, the calculation part may control a temperature of the reflection part based on an ambient temperature.

In any of the above gas measurement devices, the calculation part may control a temperature of the reflection part based on a current time.

In any of the above gas measurement devices, the calculation part may control a heating location in the reflection part based on a position of the reflection part.

In any of the above gas measurement devices, the calculation part may control a heating location in the reflection part based on a temperature distribution in the reflection part.

In any of the above gas measurement devices, the calculation part may control a heating period for the reflection part based on a temperature stability of the reflection part.

In any of the above gas measurement devices, the calculation part may calibrate the conversion information based on statistical information of a measured concentration of the target gas since the previous calibration.

In any of the above gas measurement devices, the calculation part may adjust the set value based on at least one of an ambient temperature and an ambient humidity.

In any of the above gas measurement devices, the calculation part may adjust the set value based on a mode of power consumption set in the gas measurement device.

In any of the above gas measurement devices, the calculation part may adjust the set value based on a cumulative use time of the gas measurement device.

In any of the above gas measurement devices, the calculation part may adjust the set value based on a measurement range of the reception part.

The above summary does not enumerate all of the features of the disclosure, and sub-combinations of these feature groups may also constitute inventions.

### BRIEF DESCRIPTION OF THE DRAWINGS

FIG. 1 illustrates a configuration example of a gas measurement device 100 according to one embodiment of the disclosure.

FIG. 2 is a cross-sectional view showing an overview of a reflection part 30.

FIG. 3 illustrates an example of a wavelength spectrum of reflectivity in the reflection part 30.

FIG. 4 illustrates another example of a wavelength spectrum of reflectivity in the reflection part 30.

FIG. 5 illustrates another configuration example of the gas measurement device 100.

FIG. 6 illustrates an example of temperature change of the reflection part 30.

FIG. 7 illustrates another example of temperature change of the reflection part 30.

FIG. 8 illustrates an example of a heating method of the reflection part 30.

FIG. 9 illustrates another structure example of the reflection part 30.

FIG. 10 illustrates an arrangement example of a reflection area 38 and a heated area 37.

FIG. 11 illustrates another arrangement example of the reflection area 38 and the heated area 37.

FIG. 12 illustrates another arrangement example of the reflection area 38 and the heated area 37.

FIG. 13 illustrates an example of a laminate structure of the reflection part 30.

FIG. 14 illustrates another example of a laminate structure of the reflection part 30.

FIG. 15 illustrates another example of a laminate structure of the reflection part 30.

### DESCRIPTION OF THE EMBODIMENTS

Hereinafter, the disclosure will be described through embodiments of the disclosure, but the following embodiments do not limit the inventions according to the claims. Not all combinations of features described in the embodiments are necessarily essential to the solution of the disclosure.

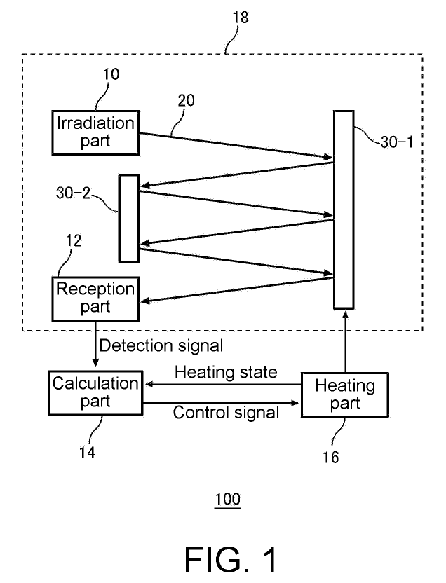

FIG. 1 illustrates a configuration example of a gas measurement device 100 according to one embodiment of the disclosure. In the gas measurement device 100, concentration information corresponding to a volume concentration of a target gas is generated. The target gas of the present example absorbs light in a wavelength band including an absorption band attributable to O–H bonds. The wavelength band is, for example, 2.5 μm or more and 3.5 μm or less. The wavelength band may be 2.9 μm or more and may be 3.3 μm or less. The target gas may be a combustible gas. The target gas may be a gas used as a refrigerant. The target gas may have a CH group. As an example, the target gas may include any one or more types of gases among alcohol, R32, R290, R1234yf, and R1234ze. The gas measurement device 100 may be installed in an air conditioning apparatus such as an air conditioner that uses a refrigerant.

The gas measurement device 100 includes an irradiation part 10, one or more reflection parts 30, a reception part 12, a calculation part 14, and a heating part 16. The reflection part 30 of the present example is arranged in a space 18 where the target gas exists. The space 18 may be a portion of a flow path of the target gas, may be an interior of a housing into which the target gas is introduced, or may be another space. The irradiation part 10 and the reception part 12 may also be arranged in the space 18.

The irradiation part 10 irradiates the target gas with irradiation light 20 including a wavelength component in at least a portion of a wavelength range of 2.5 μm or more and 3.5 μm or less. The irradiation light 20 may include a wavelength component of 2.9 μm or more and 3.3 μm or less. The irradiation part 10 is, for example, a semiconductor laser element, but is not limited thereto. The irradiation part 10 may be, for example, a thermal light source such as a microelectromechanical systems (MEMS) heater or a light bulb, or may be a photoelectric element such as a light emitting diode (LED) or an organic light emitting diode.

The reflection part 30 reflects the irradiation light 20. The reflection part 30 may include a reflective surface formed of a metal such as aluminum or gold. To prevent corrosion of the metal, the reflection part 30 may include a protective film containing SiO or SiO₂ on the surface of the reflective surface. Due to this protective film on the surface, hydroxyl groups can be formed on the surface of the reflective surface. Pores may exist in the metal of the reflective surface. The metal of the reflective surface may be subjected to sealing treatment with an organic film or the like. The presence of pores allows adsorption of moisture in the air. The reflection part 30 forms a detection space for the target gas by reflecting the irradiation light 20. The detection space is a space where the target gas exists and through which the irradiation light 20 passes. By providing the reflection part 30, even in the space 18 that is relatively small, a length of a passage optical path through which the irradiation light 20 passes through the target gas is likely to be secured. Hence, a concentration of the target gas can be measured with high accuracy. The irradiation light 20 may be incident on one reflection part 30 multiple times. For example, in the example of FIG. 1, the irradiation light 20 is multiply reflected between two reflection parts 30-1 and 30-2 arranged facing each other. The irradiation light 20 may be incident on at least one reflection part 30-1 three or more times. A portion of the wavelength component of the irradiation light 20 is absorbed by the target gas existing in an area through which the irradiation light 20 has passed. The absorbed wavelength band is determined by the type of target gas, and the magnitude of absorption is determined by the concentration of the target gas that existed in the area through which the irradiation light 20 has passed.

The reception part 12 generates a detection signal corresponding to an intensity at which the irradiation light 20 is absorbed by the target gas. The reception part 12 may include a light receiving element that measures the intensity of the irradiation light 20 received from the reflection part 30. The light receiving element may be, for example, a photodiode, a phototransistor, a thermopile, a pyroelectric sensor, or a bolometer. As described above, since the irradiation light 20 passes through the target gas, a wavelength component corresponding to the type of target gas is attenuated according to the concentration of the target gas. Hence, by measuring the intensity of the irradiation light that has passed through the target gas, the concentration of a specific target gas can be measured. To enhance the selectivity and sensitivity of gas measurement, the reception part 12 may include a wavelength selection filter so as to detect only the wavelength component corresponding to the target gas. The wavelength selection filter may be, for example, a dielectric multilayer film filter, a diffraction grating filter, a Fabry-Perot filter, or a photonic crystal. In the case where the reception part 12 includes no wavelength selection filter, a wavelength selection filter may be provided somewhere on an optical path from the irradiation part 10 to the reception part 12.

In another example, the reception part 12 may include a microphone that detects changes in sound pressure in the space 18. When the irradiation light 20 having the wavelength component corresponding to the target gas to be measured is irradiated onto the target gas, the irradiation light 20 is absorbed by the target gas, the target gas expands and the air pressure (sound pressure) in the space 18 changes. The concentration of the target gas can be measured from a magnitude of the change in sound pressure. In the present specification, the case where the reception part 12 measures the intensity of the irradiation light 20 is described, but the same applies to a method in which the reception part 12 measures the sound pressure in the space 18.

The calculation part 14 generates concentration information of the target gas based on the detection signal. The concentration information is information indicating the volume concentration of the target gas. The concentration information may include a value of the volume concentration itself, or may include information from which the value of the volume concentration can be calculated. The calculation part 14 of the present example has conversion information for converting the detection signal into concentration information. The conversion information is, for example, a calculation formula for converting the detection signal into concentration information, or a conversion table, or the like. The conversion information may be information for converting an absorption intensity of the irradiation light 20 at a set wavelength into concentration information. The calculation part 14 may perform signal processing on multiple detection signals or multiple pieces of concentration information to calculate new detection signals or concentration information. Here, signal processing may be calculating statistical values such as average values or median values, or performing digital filter processing such as finite impulse response (FIR) filters, infinite impulse response (IIR) filters, or moving averages.

The heating part 16 heats at least one reflection part 30. The heating part 16 may heat the reflection part 30 by a heating wire or the like, may heat the reflection part 30 by outputting hot air, may heat the reflection part 30 using a Peltier element, or may heat the reflection part 30 by other methods. The heating part 16 may heat all of the reflection parts 30. By heating the reflection part 30, a state of the reflective surface of the reflection part 30 is likely to be maintained as a state suitable for gas concentration measurement. The calculation part 14 may control the heating of the reflection part 30 by the heating part 16. For example, the calculation part 14 may control the heating part 16 so that the reflection part 30 reaches a predetermined temperature. The calculation part 14 may output a control signal that controls power consumption or the like in the heating part 16.

The properties of the irradiation part 10, the reflection part 30, the reception part 12 or the like may change over time. For example, the intensity of the irradiation light 20 from the irradiation part 10, the reflectivity of the reflection part 30, or the light reception sensitivity of the reception part 12 may change over time due to deterioration of elements or the like. In particular, in the case where the irradiation light 20 is reflected multiple times at the reflection part 30, the influence of changes in properties at the reflection part 30 becomes significant. The calculation part 14 may be configured to periodically calibrate the conversion information for converting the detection signal into concentration information so as to offset these changes in properties. The calculation part 14 may be a computer in which a program for executing each processing described in the present specification is installed. The calculation part 14 may execute the program recorded on a computer-readable medium. For example, the calculation part 14 causes the irradiation part 10 to emit the irradiation light 20 in a state in which the concentration of the target gas is known (for example, substantially 0 ppm), and causes the reception part 12 to receive the irradiation light 20. The conversion information is calibrated so that an attenuation amount of the received irradiation light 20 is converted to the known concentration. By such processing, errors in the concentration measurement of the target gas due to changes in properties of an optical element can be reduced. An upper limit value may be set for a correction width of the conversion information before and after calibration. The calibration of the present example compensates for aging changes. In aging changes, the properties of each element are expected to change gradually. Hence, by setting an upper limit value for a change in conversion information before and after calibration, excessive correction to the conversion information can be suppressed. In the case where a difference in conversion information before and after calibration is equal to or greater than the upper limit value, there is a possibility that the gas measurement device may be in an abnormal state. Thus, the calculation part 14 may notify a user or surroundings of the abnormality. A notification method of the abnormality may be, for example, a buzzer, a signal light, or electronic notification via communication.

Calibration may be performing at least one of the following three processings. In calibration, all of the following three processings may be performed.
(1) Calibration data acquisition
(2) Generation of calibration parameter based on calibration data
(3) Updating of conversion information based on calibration parameter

These processings may be performed continuously at the same timing, or may be performed at different timings. These processings may have different processing frequencies. Calibration data may include information based on at least one of the detection signal, a heating state of a heating part, a temperature of a reflection part, an ambient temperature of the gas measurement device, an ambient humidity of the gas measurement device, and a gas concentration calculated by the gas measurement device. For example, a calibration parameter may be statistical information generated from the calibration data acquired within a predetermined period set in advance. The statistical information is, for example but not limited to, a minimum value of the calibration data acquired within the predetermined period. For example, the statistical information may be an average value or median value of the calibration data acquired within the predetermined period, or may be a minimum value, average value, or median value of a data group in which the range of ambient temperature or ambient humidity is limited. Regarding processing frequency, at least one of the frequency of calibration data acquisition and the frequency of generation of calibration parameter may be higher than the frequency of updating of the conversion information based on the calibration parameter. The generation of calibration parameter may be performed each time the calibration data is acquired. On this occasion, at least the (1) calibration data acquisition may be executed based on a heating state of the heating part 16.

For example, in the case of performing calibration so that a minimum value of measurement data of the concentration of the target gas in a predetermined period (for example, 2 weeks) is a reference concentration (for example, 0 ppm), the following processings may be performed: (1) acquiring the latest gas concentration measurement data as calibration data; (2) saving the smaller value of a saved calibration parameter and the acquired calibration data as a new calibration parameter; and (3) updating the conversion information based on the calibration parameter (that is, the minimum value of the measurement data in the predetermined period) saved when the predetermined period has elapsed.

The calculation part 14 of the present example acquires the detection signal output by the reception part 12 and the heating state of the heating part 16 as input information, and calibrates the conversion information for converting the detection signal into concentration information according to the heating state. As described above, the calculation part 14 may perform data acquisition for calibration according to the heating state. For example, in the case where the heating state in the heating part 16 satisfies a predetermined condition, the calculation part 14 may calibrate the conversion information using a corresponding detection signal. The calculation part 14 may acquire the heating state at the time of receiving the detection signal from the reception part 12 and confirm whether the heating state satisfies the condition, or may acquire the heating state at a predetermined timing and acquire the detection signal in the case where the heating state satisfies the condition. The calculation part 14 may control the heating part 16 so that the heating state satisfies the condition, and then acquire the detection signal. By such an operation, variations in the heating state in the heating part 16 can be reduced, and the conversion information can be calibrated with high accuracy. The heating state is a state indicating how the reflection part 30 is being heated. The heating state may, for example, include at least one of the following information: an actual temperature of the reflection part 30, a target temperature of the reflection part 30 set in the heating part 16, the amount of heat that the heating part 16 is supplying to the reflection part 30, and the power consumption in the heating part 16.

The heating part 16 may heat the reflection part 30, so as to suppress moisture adsorption by the hydroxyl groups on the surface of the reflection part 30 or moisture adsorption in pores. In the case of performing calibration, the calculation part 14 may control the heating state in the heating part 16 so as to suppress moisture adsorption on the surface of the reflection part 30. When moisture contained in the air or the target gas is adsorbed to the hydroxyl groups or pores on the surface of the reflection part 30, the irradiation light 20 may be absorbed by the moisture. When the irradiation light 20 is absorbed by the moisture, even in the case where the irradiation light 20 is passed through the target gas of the same concentration, variations may occur in the intensity of the irradiation light 20 received by the reception part 12. When the detection signal in such a state is used, the conversion information cannot be calibrated with high accuracy.

In the present example, since the conversion information is calibrated based on the heating state of the heating part 16, property fluctuation of the reflection part 30 due to adsorbed moisture as described above can be suppressed, and the conversion information can be calibrated with high accuracy. For example, in the case of calibrating the conversion information, the heating part 16 may heat the reflection part 30 to 43 °C or higher. By heating the reflection part 30 to 43 °C or higher, the moisture adsorbed to the reflection part 30 is likely to be removed. The heating of the reflection part 30 may be performed for 1 second or more, may be performed for 10 seconds or more, or may be performed for 1 minute or more. A heating period of the reflection part 30 may be 10 minutes or less, may be 5 minutes or less, or may be 1 minute or less. The calculation part 14 may, based on the detection signal acquired after the heating period has elapsed, calibrate the conversion information.

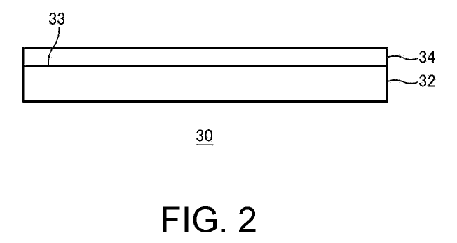

FIG. 2 is a cross-sectional view showing an overview of the reflection part 30. The reflection part 30 of the present example includes a metal portion 32 and a protective film 34. The metal portion 32 is formed of a metal such as aluminum. The metal portion 32 has a reflective surface 33 processed into a mirror-like surface. The reflection part 30 reflects the irradiation light 20 incident on the reflective surface 33. By forming the metal portion 32 with a metal including aluminum, the cost of the reflection part 30 can be reduced. The metal portion 32 may be formed by a method such as vapor deposition on a base material. The base material may be, for example, resin, ceramic, or metal.

The protective film 34 is formed of a hydrophilic material and covers the reflective surface 33 of the metal portion 32. The protective film 34 may be a film having hydroxyl groups on the surface. The protective film 34 may contain silicon. As an example, the protective film 34 is formed of hexamethyldisiloxane (HMDSO). In this case, the surface of the protective film 34 is SiOₓC_{y}, in which hydrogen is bonded to oxygen on the surface, and hydroxyl groups are formed.

The hydroxyl groups adsorb moisture in the air. The adsorption of moisture is at least one of physical adsorption and chemical adsorption. A light absorption spectrum of the hydroxyl groups has a peak in, for example, a range of 2.8 μm or more and 3.3 μm or less. When moisture is adsorbed to the hydroxyl groups of the reflection part 30, a component in the range of 2.8 μm or more and 3.3 μm or less in the absorption spectrum of the reflection part 30 changes.

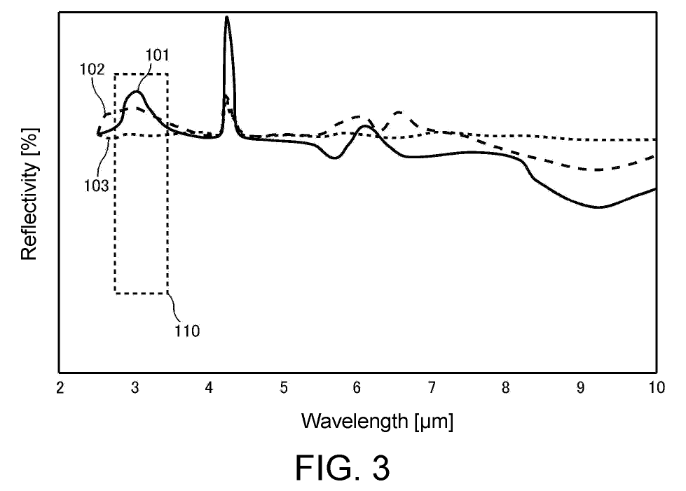

FIG. 3 illustrates an example of a wavelength spectrum of reflectivity in the reflection part 30. The reflection part 30 of the present example includes the protective film 34 formed of HMDSO. FIG. 3 shows spectra 101, 102, and 103. The spectrum 101 is a spectrum of the reflection part 30 heated to approximately 85 °C, the spectrum 102 is a spectrum of the reflection part 30 heated to approximately 60 °C, and the spectrum 103 is a spectrum of the reflection part 30 heated to approximately 25 °C.

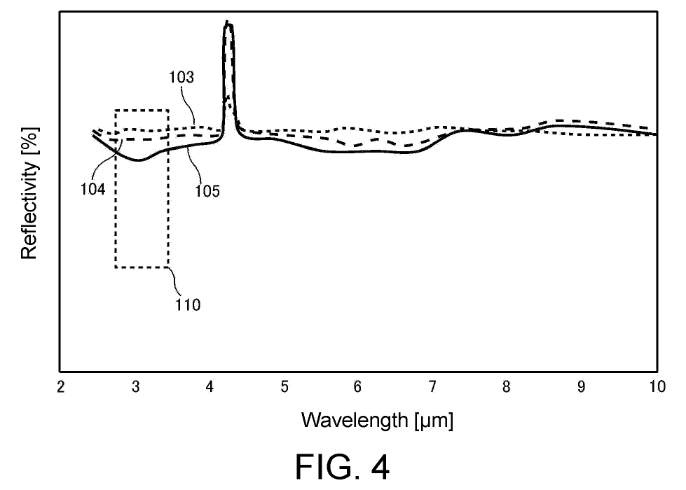

FIG. 4 illustrates another example of a wavelength spectrum of reflectivity in the reflection part 30. FIG. 4 shows spectra 103, 104, and 105. The spectrum 103 is the same as the example in FIG. 3. The spectrum 104 is a spectrum of the reflection part 30 heated to approximately 17 °C, and the spectrum 105 is a spectrum of the reflection part 30 heated to approximately 14 °C.

As shown in FIG. 3 and FIG. 4, in a band 110 of 2.8 μm or more and 3.3 μm or less, the spectrum of reflectivity changes according to the temperature of the reflection part 30. This is conceivably because the amount of moisture adsorbed to the reflection part 30 varies according to the temperature of the reflection part 30, and the reflectivity (or absorptivity) changes. For example, the higher the temperature of the reflection part 30, the smaller the amount of moisture adsorbed, the less the light absorption by moisture, and the higher the reflectivity.

In the present example, the conversion information is calibrated based on the heating state of the heating part 16. This makes it possible to suppress the property fluctuation of the reflection part 30 due to adsorbed moisture as described above, and to calibrate the conversion information with high accuracy.

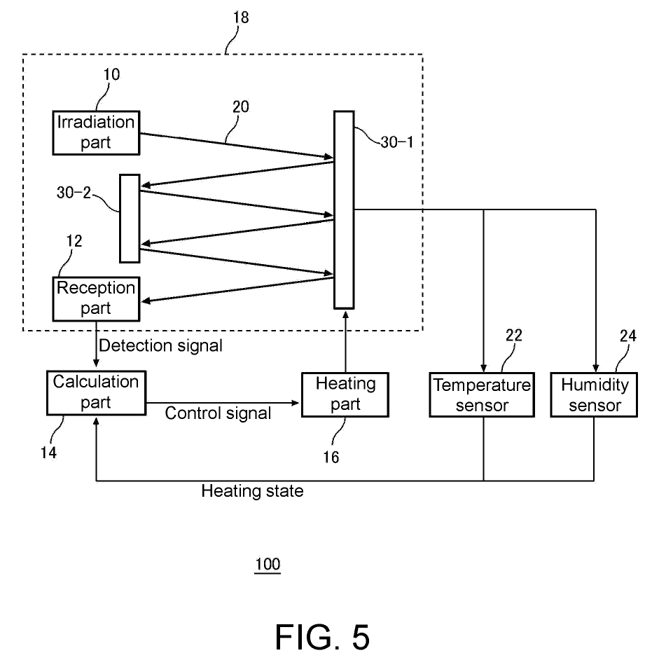

FIG. 5 illustrates another configuration example of the gas measurement device 100. The gas measurement device 100 of the present example includes one or both of a temperature sensor 22 and a humidity sensor 24 in addition to the configuration shown in FIG. 1.

The temperature sensor 22 measures a temperature of the reflection part 30. The temperature sensor 22 may measure a temperature of the reflective surface 33 of the reflection part 30, may measure a temperature of the metal portion 32, may measure a temperature of the protective film 34, or may measure a temperature of a base material of the reflection part 30. In the case where there is a temperature gradient between the temperature sensor 22 and a measurement target such as the reflective surface 33, the temperature sensor 22 may correct a measurement result based on the assumed temperature gradient and take the result as the temperature of the reflective surface 33 or the like. A correction calculation formula may be set based on an actual measurement result or may be set based on theoretical calculation.

The humidity sensor 24 measures a humidity at the reflective surface 33 of the reflection part 30. The humidity sensor 24 may measure a humidity near the surface of the protective film 34 as the humidity at the reflective surface 33. Since humidity is less likely to have a gradient compared to temperature, for example, a humidity in the space 18 or a humidity near the outside of the gas measurement device 100 may be taken as the humidity at the reflective surface 33. In the case of taking the humidity near the outside of the gas measurement device 100 as the humidity at the reflective surface 33, the gas measurement device 100 does not need to include the humidity sensor 24, and may acquire a humidity measurement result from an external source.

The temperature and the ambient humidity of the reflection part 30 change according to the heating state of the heating part 16. The calculation part 14 may receive, as the heating state of the heating part 16, one or both of the measurement result from the temperature sensor 22 and the measurement result from the humidity sensor 24.

The calculation part 14 may calibrate the conversion information based on the detection signal acquired in a state in which the temperature of the reflection part 30 or the amount of heat supplied by the heating part 16 to the reflection part 30 is higher than a set value. The set value of the temperature is, for example, 43 °C, but is not limited thereto. Through the measurements as shown in FIG. 3 and FIG. 4, when the reflection part 30 is heated to 43 °C or higher, moisture adsorbed to the protective film 34 is likely to desorb, and a decrease in the reflectivity of the reflection part 30 can be suppressed. The set value of the temperature may be 45 °C or higher, may be 47 °C or higher, or may be 50 °C or higher. The set value of the temperature may be 70 °C or lower, may be 60 °C or lower, or may be 55 °C or lower. In the case of performing calibration, the calculation part 14 may heat the reflection part 30 according to the set value.

The set value of the amount of heat may be determined corresponding to the temperature described above. A relationship between the amount of heat and the temperature of the reflection part 30 may be measured in advance and set in the calculation part 14. As the set value of the amount of heat, a set value of the power consumption of the heating part 16 may be used. A relationship between the power consumption and the amount of heat can be calculated in advance by simulation or the like. The relationship between the power consumption and the amount of heat may be calculated based on an actual measurement result.

The calculation part 14 may control the heating state of the heating part 16 based on the humidity of the reflection part 30. For example, the higher the ambient humidity of the reflection part 30, the more likely the moisture is to be adsorbed to the reflection part 30. The calculation part 14 may control the heating part 16 so that the reflection part 30 is increased in temperature as the ambient humidity of the reflection part 30 increases. The calculation part 14 may calibrate the conversion information based on the detection signal in a state in which the control is performed.

In another example, the calculation part 14 may heat the reflection part 30 so that the humidity of the reflection part 30 is 70% RH or less. The calculation part 14 may calibrate the conversion information based on the detection signal acquired in a state in which the reflection part 30 is heated to reach that humidity. As the temperature of the reflection part 30 is increased, the ambient humidity of the reflection part 30 decreases. This can suppress adsorption of moisture to the reflection part 30. The humidity may be 60% RH or less, may be 55% RH or less, or may be 50% RH or less.

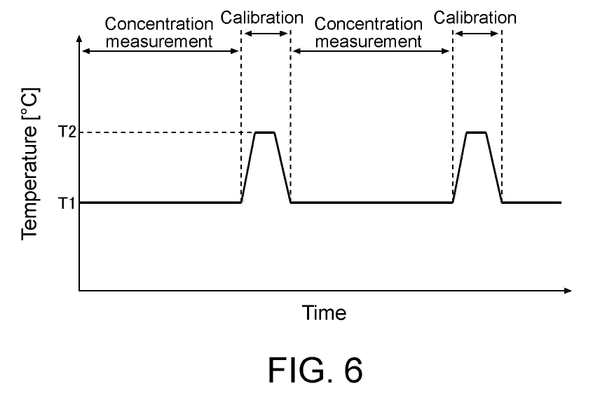

FIG. 6 illustrates an example of temperature change of the reflection part 30. The heating part 16 of the present example heats the reflection part 30 to a first state (for example, a first temperature T1) in the case of measuring the concentration information of the target gas, and heats the reflection part 30 to a second state (for example, a second temperature T2) having a higher temperature than the first state in the case of calibrating the conversion information. That is, the heating part 16 of the present example also heats the reflection part 30 also during a normal concentration measurement operation other than during calibration. The heating part 16 may heat the reflection part 30 to the first temperature T1 that is slightly higher than the ambient temperature. For example, the heating part 16 may heat the reflection part 30 to the first temperature T1 that is approximately 1 °C higher than the ambient temperature. Accordingly, condensation in the reflection part 30 can be suppressed. Hence, fluctuation of the reflectivity of the reflection part 30 due to condensation can be suppressed.

The second temperature T2 is higher than the first temperature T1. The second temperature T2 is, for example, 43 °C or higher. The second temperature T2 may be 5 °C or more, 10 °C or more, or 15°C or more, higher than the first temperature T1. A difference between the second temperature T2 and the first temperature T1 may be 30 °C or less, may be 25 °C or less, or may be 20 °C or less.

In the present example, the reflection part 30 is heated to the second temperature T2 only during calibration, and is heated to the first temperature T1 that is relatively low during normal operation. Accordingly, high-accuracy measurement, high-accuracy calibration, and low power consumption can be achieved.

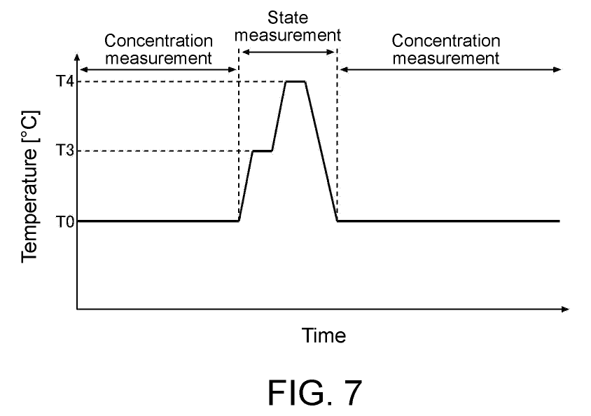

FIG. 7 illustrates another example of temperature change of the reflection part 30. The gas measurement device 100 of the present example performs a normal concentration measurement operation and a state measurement operation. In the state measurement operation, in the case where fluctuation occurs in a measurement result of the concentration of the target gas, the gas measurement device 100 estimates a cause of fluctuation. In the state measurement operation, the heating part 16 changes the heating state of the reflection part 30. The heating part 16 may change the temperature of the reflection part 30 from an initial temperature T0. The heating part 16 may sequentially transition the temperature of the reflection part 30 to one or more temperatures other than the initial temperature T0. In the example of FIG. 7, the temperature of the reflection part 30 transitions in the order of a third temperature T3 and a fourth temperature T4 (T0<T3<T4). The initial temperature T0 may be the same as the ambient temperature of the reflection part 30. The third temperature T3 may be the same temperature as the first temperature T1 described above. The fourth temperature T4 may be the same temperature as the second temperature T2 described above.

In the gas measurement device 100, the irradiation light 20 may be irradiated and the concentration of the target gas may be detected each time the temperature of the reflection part 30 is changed. In the case where the detected concentration of the target gas does not change even if the temperature of the reflection part 30 is changed, the calculation part 14 may determine that the actual concentration of the target gas has changed.

The calculation part 14 may estimate a state of the reflection part 30 based on a change in the detection signal corresponding to a change in the heating state of the heating part 16. In the case where the detected concentration of the target gas changes with a temperature change of the reflection part 30, the calculation part 14 may determine that condensation or adsorption of moisture has occurred in the reflection part 30. In this case, the calculation part 14 may notify the user or the like to that effect.

Based on the change in the detection signal, the calculation part 14 may determine whether the reflection part 30 is in a state in which condensation has occurred or a state in which moisture has been adsorbed. For example, in the case where the detected concentration of the target gas changes when the reflection part 30 is heated to the third temperature T3, the calculation part 14 may determine that condensation has occurred in the reflection part 30. In the case where the detected concentration of the target gas changes when the reflection part 30 is heated from the third temperature T3 to the fourth temperature T4, the calculation part 14 may determine that moisture adsorption has occurred in the reflection part 30. The calculation part 14 may control the heating state of the heating part 16 according to the state of the reflection part 30. For example, in the case where condensation has occurred in the reflection part 30, the calculation part 14 may set the temperature of the reflection part 30 during normal concentration measurement to be relatively high. In the case where moisture adsorption has occurred in the reflection part 30, the calculation part 14 may set the temperature of the reflection part 30 during calibration to be relatively high.

The heating part 16 may control the temperature of the reflection part 30 based on the ambient temperature of the reflection part 30. The heating part 16 may control a set value of at least one of the first temperature T1 and the second temperature T2 based on the ambient temperature. As described above, the heating part 16 may control the first temperature T1 of the reflection part 30 so as to prevent condensation from occurring in the reflection part 30.

The heating part 16 may control the temperature of the reflection part 30 based on a current time. For example, during a preset time period such as at night, the heating part 16 may set the set value of at least one of the first temperature T1 and the second temperature T2 higher than in other time periods. By such control, the temperature of the reflection part 30 is likely to be maintained during a time period during which the temperature of the reflection part 30 is likely to decrease.

The heating part 16 may control a heating location in the reflection part 30 based on a position of the reflection part 30. For example, a portion of the reflection part 30 at a relatively low height may be heated more strongly than a portion at a relatively high height. Since cold gas gathers on the side lower in height compared to warm gas, by controlling the heating location in such a manner, the entire reflection part 30 can be efficiently transitioned to a predetermined temperature state.

The heating part 16 may control the heating location in the reflection part 30 based on a temperature distribution in the reflection part 30. The heating part 16 may control the heating location in the reflection part 30 so that a temperature distribution on the reflective surface 33 of the reflection part 30 approaches uniformity. The temperature distribution in the reflection part 30 may be acquired using multiple temperature sensors 22.

The heating part 16 may control a heating period for the reflection part 30 based on a temperature stability of the reflection part 30. The heating period may be a heating period during which calibration of the conversion information is performed. The temperature stability may refer to shortness of time until the temperature of the reflection part 30 converges when the reflection part 30 is heated. The heating part 16 may shorten the heating period as the time until the temperature of the reflection part 30 converges is reduced. The heating part 16 may determine whether the temperature of the reflection part 30 has converged using the temperature sensor 22. The heating part 16 may determine that the temperature of the reflection part 30 has converged in the case where a time during which the temperature fluctuation of the reflection part 30 is maintained within, for example, a range of ±0.5 °C, is longer than a predetermined value. The predetermined value is, for example, 10 minutes, but is not limited thereto. By such control, the conversion information can be calibrated based on the detection signal after the temperature of the reflection part 30 has converged. Hence, the conversion information can be calibrated with high accuracy.

The calculation part 14 may calibrate the conversion information based on statistical information of a measured concentration of the target gas since the previous calibration. The measured concentration of the target gas is a concentration acquired in the case where the heating state in the reflection part 30 is a state (for example, a temperature of 43 °C or higher) suitable for calibration. The statistical information includes at least one of an average value, a maximum value, a minimum value, a variance, a moment, and a histogram of multiple measured concentrations. Specifically, the calculation part 14 may calibrate the conversion information using a minimum measured concentration among multiple measured concentrations measured within a predetermined period. The calculation part 14 may calibrate the conversion information by estimating that the minimum measured concentration corresponds to 0 ppm. The calculation part 14 may use, instead of the minimum measured concentration, the average value, or an average value in a predetermined period including the minimum measured concentration, or any other statistical value such as a mode or a median of the measured concentrations.

The calculation part 14 may adjust the above-described set value based on at least one of the ambient temperature and the ambient humidity of the reflection part 30. As described above, the set value is a reference value of temperature, humidity, or amount of heat for determining whether the reflection part 30 is in the state suitable for calibration. The calculation part 14 may increase the set value as the ambient temperature is increased, and may increase the set value as the ambient humidity is increased. Accordingly, in a state in which the more moisture there is in the surroundings and the more likely adsorption is to occur, the higher the temperature of the reflection part 30, calibration can be performed.

The calculation part 14 may adjust the above-described set value based on a mode of power consumption set in the gas measurement device 100. For example, the gas measurement device 100 may have a low power consumption mode and a normal mode. In the case where the gas measurement device 100 operates in the low power consumption mode, the calculation part 14 may lower the above-described set value compared to the case where the gas measurement device 100 operates in the normal mode. An operation mode of the gas measurement device 100 may be set by the user or the like, or may be automatically set according to a state of the gas measurement device 100. The state of the gas measurement device 100 is, for example, a remaining battery level.

The calculation part 14 may adjust the above-described set value based on a cumulative use time of the gas measurement device 100. For example, with use of the gas measurement device 100, the protective film 34 of the reflection part 30 may deteriorate, and the amount of moisture adsorbed may increase. The calculation part 14 may increase the above- described set value as the cumulative use time of the gas measurement device 100 increases. Accordingly, the reflection part 30 can be heated so as to offset the deterioration of the protective film 34, and moisture adsorption can be suppressed.

The calculation part 14 may adjust the above-described set value based on a measurement range of the reception part 12. The measurement range of the reception part 12 refers to a range between an upper limit value and a lower limit value of concentration that the reception part 12 can measure. The reception part 12 digitizes and measures the intensity of the irradiation light 20 with a preset number of gradations within the measurement range. Hence, the smaller the width of the measurement range, the smaller the minimum unit of the measured value, and the higher the resolution. The reception part 12 of the present example may have a variable measurement range. The calculation part 14 may increase the above-described set value as the width of the measurement range of the reception part 12 is reduced. Accordingly, the higher the measurement resolution of the reception part 12, the more the amount of moisture adsorbed to the reflection part 30 during calibration can be suppressed, and the influence on measurement can be reduced.

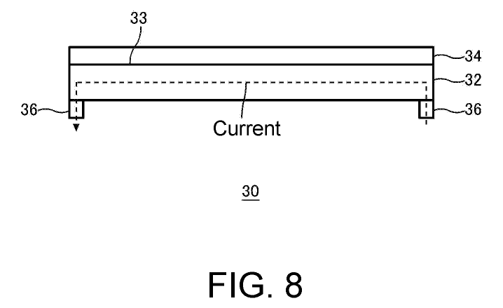

FIG. 8 illustrates an example of a heating method of the reflection part 30. The reflection part 30 of the present example includes two or more electrodes 36 electrically connected to the metal portion 32. The heating part 16 of the present example heats the reflection part 30 by passing current through the metal portion 32 of the reflection part 30. The heating part 16 passes current through the metal portion 32 via the electrode 36. Accordingly, the reflection part 30 can be heated. The electrode 36 may be provided on a surface different from the reflective surface 33 in the metal portion 32.

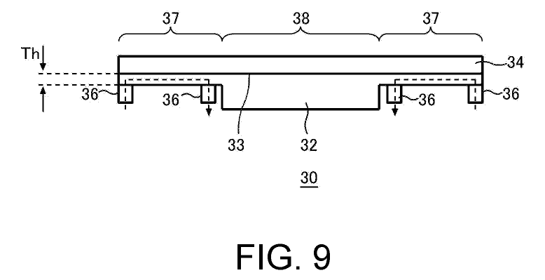

FIG. 9 illustrates another structural example of the reflection part 30. The metal portion 32 of the reflection part 30 of the present example includes a reflection area 38 and a heated area 37. The reflective surface 33 is provided in the reflection area 38. The reflective surface 33 may or may not be provided in the heated area 37. The heated area 37 is provided adjacent to the reflection area 38. Between the heated area 37 and the reflection area 38, the metal portion 32 may be formed continuously, or may be electrically insulated by an insulator.

The heated area 37 is an area having higher electrical resistance than the reflection area 38. In the present example, high electrical resistance refers to high electrical resistance per unit length in a direction in which current flows. The direction in which current flows is a direction connecting two electrodes 36 provided in the heated area 37. The heated area 37 of the present example has a smaller thickness than the reflection area 38 in a direction perpendicular to the direction in which current flows. The thickness in the present example refers to a thickness in a lamination direction in which the metal portion 32 and the protective film 34 are laminated. A thickness Th of the heated area 37 may be half or less, or 1/4 or less, of a thickness of the reflection area 38.

The heated area 37 includes an area where the thickness Th is 1 μm or less. An area between two electrodes 36 may be have a thickness of 1 μm or less. The thickness Th may be 0.5 μm or less. Preferably, the thickness Th may be 50 nm or more so that the surface’s unevenness on the base material 40 can be filled. The heating part 16 passes current through the heated area 37. In the heated area 37 of the present example, two electrodes 36 are provided. The heating part 16 may flow current through the heated area 37 via the two electrodes 36. The current may be direct current or alternating current, or may be a current pulse.

The reflection part 30 may include multiple heated areas 37. The reflection area 38 of the present example is arranged sandwiched between two heated areas 37. The heated area 37 may be provided so as to surround the reflection area 38. The heating part 16 may heat all of the multiple heated areas 37, or may selectively heat some of the heated areas 37.

By providing the heated area 37 having a high resistance value, heating by current becomes easy. The heated area 37 may be formed of a material having higher resistivity than the reflection area 38.

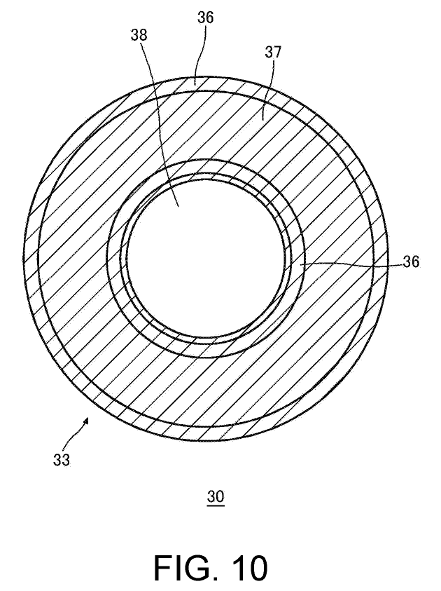

FIG. 10 illustrates an arrangement example of the reflection area 38 and the heated area 37. FIG. 10 shows an arrangement of each area when viewed in a direction perpendicular to the reflective surface 33. In FIG. 10, diagonal hatching is attached to the heated area 37, and no hatching is attached to the reflection area 38.

The reflection area 38 may be arranged so as to include a center of gravity position in the shape of the reflective surface 33. Accordingly, an area having relatively good reflection properties on the reflective surface 33 can be used as the reflection area 38. As shown in FIG. 10, in the case where the reflective surface 33 is circular, a center of gravity position is the center of the circle. The reflection area 38 may have a circular shape or any other shape. The center of gravity position of the reflection area 38 may coincide with the center of gravity position of the reflective surface 33.

The heated area 37 is arranged outside the reflection area 38 on the reflective surface 33. The heated area 37 may be arranged so as to surround a periphery of the reflection area 38. The heated area 37 of the present example has an annular shape concentric with the reflection area 38. Such an arrangement allows the reflection area 38 to be heated uniformly. Each electrode 36 may also be arranged so as to surround the reflection area 38. The electrode 36 of the present example has an annular shape concentric with the reflection area 38.

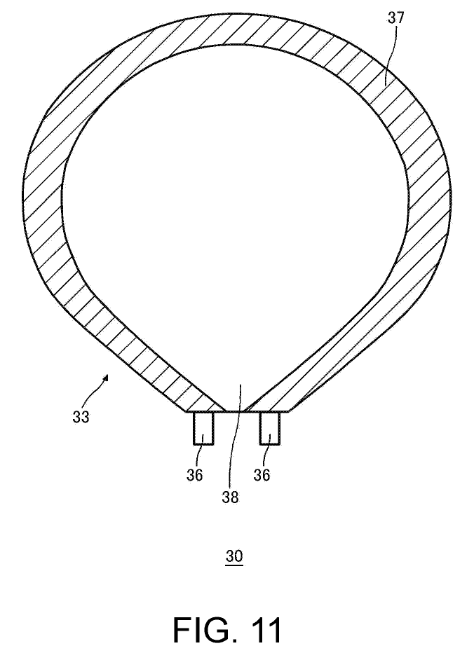

FIG. 11 illustrates another arrangement example of the reflection area 38 and the heated area 37. FIG. 11 shows an arrangement of each area when viewed in a direction perpendicular to the reflective surface 33. In FIG. 11, diagonal hatching is attached to the heated area 37, and no hatching is attached to the reflection area 38.

The reflection area 38 may be arranged so as to include the center of gravity position in the shape of the reflective surface 33. The reflection area 38 may have a circular shape or any other shape. The center of gravity position of the reflection area 38 may coincide with the center of gravity position of the reflective surface 33.

The heated area 37 is arranged outside the reflection area 38 on the reflective surface 33. The heated area 37 may be arranged so as to surround the periphery of the reflection area 38. However, the reflection area 38 of the present example is not a closed area completely surrounded by the heated area 37, but is an open area in which a portion of the area is not surrounded. The heated area 37 of the present example is provided in a band shape outside the reflection area 38. The heated area 37 may be a portion of an annular shape concentric with the reflection area 38. The electrode 36 is provided at each of both ends of the band-shaped heated area 37. The electrode 36 may be provided in an area not overlapping the reflection area 38 and the heated area 37, or may be provided in an area overlapping the heated area 37. An insulating material may be provided between the heated area 37 and the reflection area 38. Due to such an arrangement, by a simple configuration of the electrode 36, the periphery of the reflection area 38 can be heated substantially uniformly.

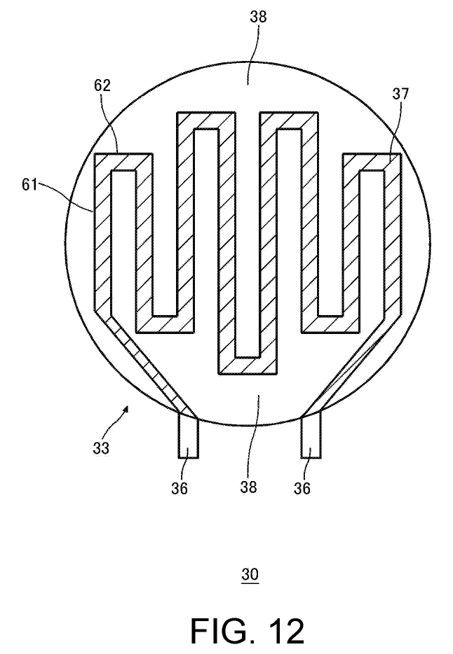

FIG. 12 illustrates another arrangement example of the reflection area 38 and the heated area 37. FIG. 12 shows an arrangement of each area when viewed in a direction perpendicular to the reflective surface 33. In FIG. 12, diagonal hatching is attached to the heated area 37, and no hatching is attached to the reflection area 38.

The heated area 37 of the present example also has a band shape. However, the heated area 37 of the present example is not provided outside the reflection area 38. At least a portion of the heated area 37 is arranged sandwiched by the reflection area 38. The heated area 37 of the present example is provided extending from the electrode 36 provided at an end of the reflective surface 33 toward the inside of the reflective surface 33. The heated area 37 may be arranged so as to scan the inside of the reflective surface 33 in a zigzag pattern. For example, the heated area 37 may include multiple first portions 61 provided in parallel and a second portion 62 connecting the ends of two adjacent first portions 61. An insulating material may be provided between the heated area 37 and the reflection area 38. The heated area 37 of the present example may be laminated on the reflection area 38 in a direction perpendicular to the reflective surface 33. In the present example as well, by a simple configuration of the electrode 36, the reflection area 38 can be heated substantially uniformly.

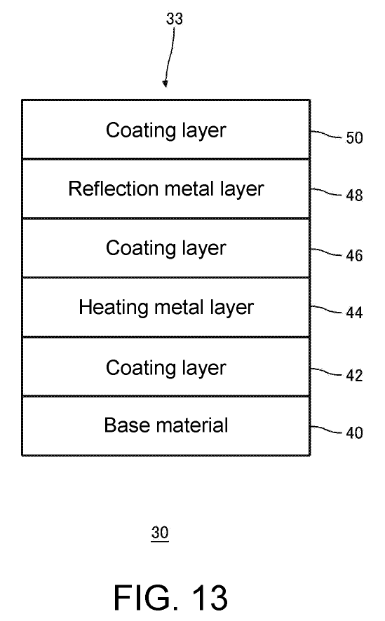

FIG. 13 illustrates an example of a laminate structure of the reflection part 30. FIG. 13 shows a portion of a cross section perpendicular to the reflective surface 33. In the reflection part 30 of the present example, a base material 40, a heating metal layer 44, and a reflection metal layer 48 are laminated in the direction perpendicular to the reflective surface 33.

The base material 40 is a substrate on which each layer is laminated. A material of the base material 40 is not particularly limited, and may be, for example, ceramic, plastic, resin, semiconductor, or metal. The heating metal layer 44 is laminated on the base material 40. The heating metal layer 44 functions as the heated area 37. In the heating metal layer 44 of the present example, a heating current flows in a direction horizontal to the reflective surface 33. The heating metal layer 44 is a layer having greater resistance than the reflection metal layer 48 in the direction horizontal to the reflective surface 33. The heating metal layer 44 may be formed of a material having higher resistivity than the reflection metal layer 48. A coating layer 42 may be provided between the heating metal layer 44 and the base material 40. The coating layer 42 may be formed of an insulating material. A layer of a conductive material such as polysilicon may be provided instead of the heating metal layer 44.

The reflection metal layer 48 is laminated on the heating metal layer 44. The reflection metal layer 48 functions as the reflection area 38. A coating layer 46 is provided between the heating metal layer 44 and the reflection metal layer 48. The coating layer 42 is formed of an insulating material. A coating layer 50 is provided on the reflective surface 33 of the reflection metal layer 48. The coating layer 50 may be formed of a material having higher transmittance than the coating layer 46.

According to the present example, the reflection area 38 and the heated area 37 can be provided in an overlapping manner. Hence, the area of the reflection area 38 is likely to be secured. By causing the entire reflection area 38 to overlap the heated area 37, the reflection area 38 can be heated uniformly. In each example described in FIG. 10 to FIG. 12, the heated area 37 may be provided in an area overlapping the reflection area 38.

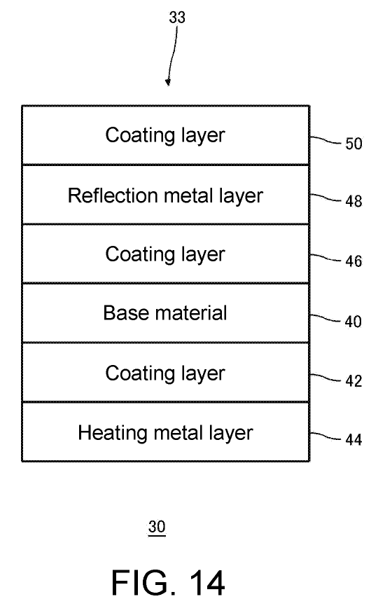

FIG. 14 illustrates another example of the laminate structure of the reflection part 30. FIG. 14 shows a portion of a cross section perpendicular to the reflective surface 33. The reflection part 30 of the present example differs from the example of FIG. 13 in the order of lamination. The materials of each layer and the like are the same as in the example of FIG. 13.

In the present example, the heating metal layer 44 is laminated on one surface of the base material 40, and the reflection metal layer 48 is laminated on the other surface. The coating layer 42 may be provided between the heating metal layer 44 and the base material 40. The coating layer 46 may be provided between the reflection metal layer 48 and the base material 40. The coating layer 50 may be provided on the reflective surface 33 of the reflection metal layer 48. By doing so, the front surface and the back surface of the base material 40 can be coated separately during production, and the range of material selection can be expanded.

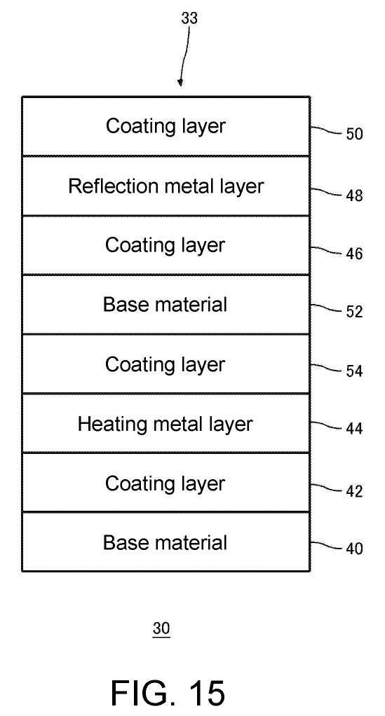

FIG. 15 illustrates another example of the laminate structure of the reflection part 30. FIG. 15 shows a portion of a cross section perpendicular to the reflective surface 33. The reflection part 30 of the present example further includes a base material 52 and a coating layer 54 in addition to the structure shown in FIG. 13. Other structures are the same as in the example of FIG. 13. By doing so, the heating metal layer 44 can be sandwiched and protected by the base materials, which makes it possible to enhance reliability such as oxidation prevention and to increase resistance to scratches.

The base material 52 is provided between the heating metal layer 44 and the reflection metal layer 48. The base material 52 may be formed of the same material as the base material 40, or may be formed of a material having a higher thermal conductivity than the base material 40. The base material 52 may be thinner than the base material 40. The coating layer 46 is provided between the base material 52 and the reflection metal layer 48. The coating layer 54 is provided between the base material 52 and the heating metal layer 44. The coating layer 54 may be formed of an insulating material. The coating layer 54 may be an adhesive layer. In this case, the reflection part 30 may be produced by bonding a unit from the base material 40 to the heating metal layer 44 and a unit from the base material 52 to the coating layer 50 with the coating layer 54.

Although the disclosure has been described above using the embodiments, the technical scope of the disclosure is not limited to the scope described in the above embodiments. It is apparent to those skilled in the art that various modifications or improvements can be added to the above embodiments. It is apparent from the description of the claims that forms with such modifications or improvements can also be included in the technical scope of the disclosure.

It should be noted that the execution order of each process such as operations, procedures, steps, and stages in the devices, systems, programs, and methods shown in the claims, specification, and drawings can be realized in any order unless specifically indicated as “before” or “prior to,” and unless the output of a previous processing is used in a subsequent processing. Even if the operation flows in the claims, specification, and drawings are described using “first,” “next,” or the like for convenience, this does not mean that implementation in this order is mandatory.

What is claimed is:

1. A gas measurement device comprising:
an irradiation part, irradiating a target gas with irradiation light comprising a wavelength component in at least a portion of a wavelength range of 2.5 μm or more and 3.5 μm or less;
a reflection part, reflecting the irradiation light and forming a detection space for the target gas;
a reception part, generating a detection signal corresponding to an intensity at which the irradiation light is absorbed by the target gas;
a calculation part, generating concentration information of the target gas based on the detection signal; and
a heating part, heating the reflection part, wherein
the reflection part comprises a metal portion containing aluminum and a protective film containing silicon;
the calculation part is configured to calibrate conversion information for converting the detection signal into the concentration information;
the calibration comprises data acquisition for the calibration; and
the calculation part acquires the detection signal and a heating state of the heating part as input information, and performs data acquisition for the calibration according to the heating state.

2. The gas measurement device according to claim 1, wherein
the calibration further comprises:
generation of a calibration parameter based on data for the calibration; and
updating of the conversion information based on the calibration parameter.

3. The gas measurement device according to claim 2, wherein
at least one of a frequency of data acquisition for the calibration and a frequency of generation of the calibration parameter based on data for the calibration is higher than a frequency of updating of the conversion information based on the calibration parameter.

4. The gas measurement device according to claim 1, wherein
the calculation part calibrates the conversion information based on the detection signal acquired in a state in which a temperature of the reflection part or an amount of heat supplied by the heating part to the reflection part is higher than a set value.

5. The gas measurement device according to claim 4, further comprising:
a temperature sensor, measuring a temperature of the reflection part.

6. The gas measurement device according to claim 1, further comprising:
a humidity sensor measuring humidity at a reflective surface of the reflection part, wherein
the heating part controls the heating state based on the humidity.

7. The gas measurement device according to claim 6, wherein
the calculation part calibrates the conversion information based on the detection signal acquired in a state in which the reflection part is heated so that the humidity is 70% RH or less.

8. The gas measurement device according to claim 1, wherein
the heating part heats the reflection part to a first state in a case of measuring the concentration information of the target gas, and heats the reflection part to a second state having a higher temperature than the first state in a case of calibrating the conversion information.

9. The gas measurement device according to claim 1, wherein
the heating part changes the heating state of the reflection part; and
the calculation part estimates a state of the reflection part based on a change in the detection signal corresponding to a change in the heating state.

10. The gas measurement device according to claim 9, wherein
the calculation part determines whether the reflection part is in a state in which condensation has occurred or a state in which moisture has been adsorbed based on a change in the detection signal.

11. The gas measurement device according to claim 1, wherein
the heating part heats the reflection part to 43 °C or higher in a case of calibrating the conversion information.

12. The gas measurement device according to claim 1, wherein
the heating part heats the reflection part by passing a current through the metal portion of the reflection part.

13. The gas measurement device according to claim 12, wherein
the metal portion comprises:
a reflection area provided with a reflective surface; and
a heated area provided adjacent to the reflection area and having a higher electrical resistance than the reflection area, wherein
the heating part passes a current through the heated area.

14. The gas measurement device according to claim 13, wherein
the heated area comprises an area having a thickness of 1 μm or less in a direction perpendicular to a direction in which the current flows.

15. The gas measurement device according to claim 1, wherein
one or more reflection parts are provided,
the irradiation light is reflected at least three times in total by the reflection parts on an optical path of the irradiation light from the irradiation part to the reception part.

16. The gas measurement device according to claim 1, wherein
the calculation part controls a temperature of the reflection part based on an ambient temperature.

17. The gas measurement device according to claim 1, wherein
the calculation part controls a temperature of the reflection part based on a current time.

18. The gas measurement device according to claim 1, wherein
the calculation part controls a heating location in the reflection part based on a temperature distribution in the reflection part.
